(19) United States
(12) Patent Application Publication
(10) Pub. No.: US 2021/0154755 A1
(43) Pub. Date: May 27, 2021

(54) FOLDABLE TABLE SAW EXTENSION ASSEMBLY

(71) Applicant: JPW Industries Inc., La Vergne, TN (US)

(72) Inventor: Tobias M. Bridges, Holly Springs, NC (US)

(21) Appl. No.: 17/105,751

(22) Filed: Nov. 27, 2020

Related U.S. Application Data
(60) Provisional application No. 62/940,952, filed on Nov. 27, 2019.

(51) Int. Cl. B23D 47/02

(52) U.S. Cl. CPC B23D 47/025

(57) ABSTRACT

A table saw apparatus is disclosed that includes a main table saw base. A motorized rotatable blade can be disposed on the main table saw base. The table saw apparatus can include a table saw extension assembly. The table saw extension assembly can include at least one extension member, such as an extension rail, pivotally connected to the main table saw base, the at least one extension rail movable to an extended position such that the at least one extension rail extends laterally from the main table saw base, and at least one support leg pivotally connected to the at least one extension rail. The extension assembly disclosed can be retrofitted to existing table saws to provide a foldable laterally extending support assembly for the table saw.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application is a non-provisional of U.S. Patent Application No. 62/940,952 filed Nov. 27, 2019 entitled FOLDABLE TABLE SAW LEG SUPPORT, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to table saws. Table saws can generally include a main base and a rotatable blade disposed on the main base. The base can include a main work table or work surface through which the blade can extend. Work pieces can be fed toward or past the rotatable blade on the work table to perform a desired cut on the work piece. Table saws can be using to cut sheets or wider boards of wood or other material, often along a length of the work piece. Many conventional tables only have a few feet of space between the saw blade and a lateral edge of the work table of the main base.

In conventional table saws, longer pieces needing to be cut in a direction transverse to their lengths would typically have to hang laterally off the work table of the table saw as the work piece is being cut, which can make it cumbersome to maneuver the work piece during the cut and maintain a proper or desired cut of the work piece. Alternatively, larger work tables could be used to support the longer work pieces needing to be cut transverse to their length. Larger work tables however mean a larger footprint for the table saw within a work space.

Some conventional table saws have included telescoping rails that can be extended from a main side rail of the table saw to help support longer work pieces. However, such telescoping rails can provide uneven rail surfaces between the main rail and the extension rails, which can make it difficult to move fencing assemblies along the entire length of the extended rail, and the uneven surfaces can make measuring the length of a cut difficult.

What is needed then are improvements to table saw apparatuses.

### SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a table saw apparatus including a main table saw base. A motorized rotatable blade can be disposed on the main table saw base. The table saw apparatus can include a table saw extension assembly. The table saw extension assembly can include at least one extension member pivotally connected to the main table saw base, the at least one extension member movable to an extended position such that the at least one extension member extends laterally from the main table saw base, and at least one support leg pivotally connected to the at least one extension member. In some embodiments, the extension member can be an extension rail pivotally connected to a side rail of the main table saw base. In other embodiments, the extension member can be a table extension that can be pivotally connected to the main table saw base.

Another aspect of the present disclosure is a table saw apparatus including a main table saw base having an upper work table, a motorized rotatable blade disposed on the main table saw base and extending through the upper work table, the rotatable blade rotating along a rotational plane, and a first side rail and a second side rail extending in a direction transverse to the rotational plane adjacent opposing edges of the upper work table, the first side rail having a first side rail end and the second side rail having a second side rail end. The apparatus can include a table saw extension assembly including a first extension rail having a first proximal end and a first distal end, the first proximal end pivotally connected to the first end of the first side rail, a second extension rail having a second proximal end and a second distal end, the second proximal end pivotally connected to the second end of the second side rail, a first support leg pivotally connected to the first distal end of the first extension rail; and a second support leg pivotally connected to the second distal end of the second extension rail.

Another aspect of the present disclosure is an extension assembly apparatus that can be retrofitted to a table saw having a motorized rotatable blade and first and second side rails extending on opposing sides of the rotatable blade in a lateral direction, the extension assembly apparatus including a first extension rail having a first proximal end and a first distal end, the first proximal end pivotally connectable to the first side rail, and a second extension rail having a second proximal end and a second distal end, the second proximal end pivotally connectable to the second side rail, wherein when the first and second extension rails are connected to the first and second side rails respectively, the first and second extension rails are movable to an extended position such that the first and second extension rails are in a flush orientation with the first and second side rails respectively. A first support leg can be pivotally connected to the first distal end of the first extension rail, and a second support leg can be pivotally connected to the second distal end of the second extension rail. A cross support member can extend between the first and second extension rails.

Having at least one extension rail that can pivot to an extended position where the at least one extension rail can extend laterally from the table saw base can allow longer work pieces to be supported on the extension assembly during a cutting operation. Having the at least one extension rail be pivotally connected to the main table saw base and the at least one support leg pivotally connected to the at least one extension rail can allow the at least one support leg to be folded toward the at least one extension rail and the at least one extension rail to be folded downward toward the main table saw base to place the table saw extension assembly in a stored, lowered, or retracted position to decrease the overall footprint of the table saw apparatus when additional lateral support is not needed. In some embodiments, when the extension rail is in the extended position, top surfaces of the extension rail and a corresponding side rail can have a flush orientation which can facilitate a smooth transition between the side rail and the extension rail which can allow for easier movement of fencing assemblies down the side rail and the extension rail and allow for a substantially continuous measuring element to extend across the side rail and the extension rail.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of a table saw apparatus of the present disclosure with the extension assembly in a stored position.

FIG. 2 is a perspective view of the table saw apparatus of FIG. 1 showing the extension rails moving toward an extended position.

FIG. 3 is a detailed perspective view showing channels in the extension rails into which support legs can be received.

FIG. 4 is a perspective view of the table saw apparatus of FIG. 1 showing the support legs moving away from the extension rails toward a support position.

FIG. 5 is a top perspective view of the table saw apparatus of FIG. 1 with the extension rails in an extended position and support legs in a vertical support position.

FIG. 5a is a detailed view of a measurement device extending across a side rail and corresponding extension rail of the table saw apparatus of FIG. 5.

FIG. 6 is a perspective view of the table saw apparatus of FIG. 1 showing a table insert being positioned between the extension rails of the extension assembly.

FIG. 7 is a perspective view of the table saw apparatus of FIG. 6 with the table insert positioned between the extension rails and supported by a cross support member extending between the extension rails.

FIG. 8 is a partial side view of a telescoping leg and an adjustable foot on the support leg of the table saw apparatus of FIG. 7.

FIG. 9 is a perspective detailed view of a latch for securing the extension rail and thus the extension assembly to the side rail of the table saw apparatus of FIG. 1.

FIG. 10 is a cross sectional view of the latch of FIG. 9.

FIG. 11 is a partial cross sectional view of another embodiment of an extension assembly of the present disclosure wherein the extension rail includes a magnet for securing the support leg adjacent the extension rail.

FIG. 12 is a perspective detailed view of a hinge assembly for pivotally connecting an extension rail of the present disclosure to a side rail of a table saw.

FIG. 13 is a top view of the table saw apparatus of FIG. 7 with a fence disposed on the extension rails of the extension assembly for performing a cutting operation on a longer work piece via the table saw apparatus.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

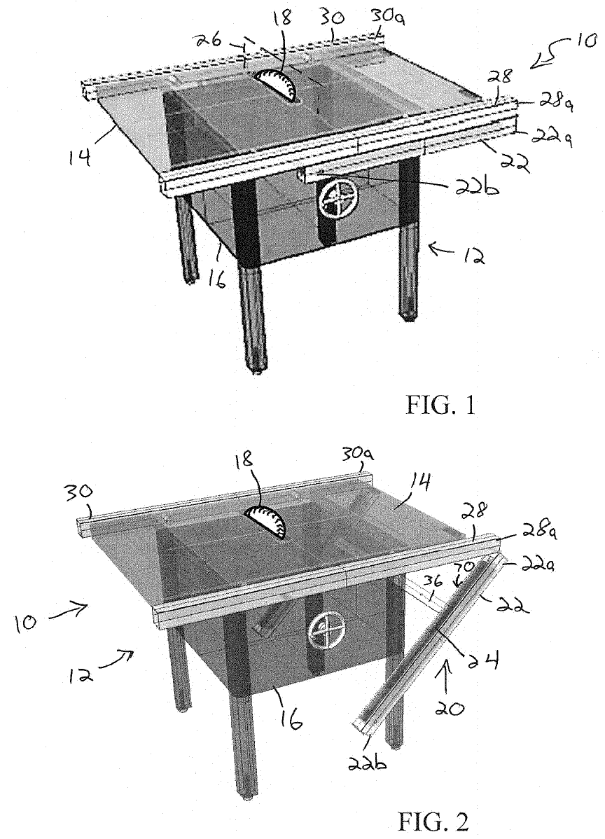

As shown in FIGS. 1-7, one aspect of the present disclosure is a table saw apparatus 10 including a main table saw base 12. The main table saw base 12 can include an upper work table 14 and a base housing 16. A motorized rotatable blade 18 can be disposed on the main table saw base 12. The rotatable blade 18 can extend through the upper work table 14 such that the rotatable blade 18 can perform a cut on a work piece positioned on the upper work table 14. The motor for the rotatable blade 18 and other components of the table saw apparatus 10 can be housed in the base housing 16.

The table saw apparatus 10 can include a table saw extension assembly 20. The table saw extension assembly 20 can include at least one extension rail 22 pivotally connected to the main table saw base 12, the at least one extension rail 22 movable to an extended position (as shown in FIGS. 2-5), such that the at least one extension rail 22 extends laterally from or towards a lateral side of the main table saw base 12 when the table saw apparatus 10 is viewed from the front, and at least one support leg 24 pivotally connected to the at least one extension rail 22.

From the stored position shown in FIG. 1, the extension rail 22 can be pivoted to an extended position as shown in FIGS. 1-5, and the support leg 24 can be pivoted away from the extension rail 22 such that support leg 24 can be generally oriented in a vertical orientation for engagement with the ground to support the extension rail 22. Having at least one extension rail 22 that can move to an extended position where the at least one extension rail 22 can extend laterally from the main table saw base 12 can allow longer work pieces to be supported laterally on the extension assembly 20 during a cutting operation. Having the at least one extension rail 22 pivotally connected to the main table saw base 12 and the at least one support leg 24 pivotally connected to the at least one extension rail 22 can allow the at least one support leg 24 to be folded toward the at least one extension rail 22 and the at least one extension rail 22 to be folded downward toward the main table saw base 12 to place the table saw extension assembly 20 in a stored or retracted position (as shown in FIG. 1) to decrease the overall footprint of the table saw apparatus 10 when additional lateral support is not needed.

In some embodiments, the rotatable blade 18 rotates on the main table saw base 12 along a rotational plane 26. The main table saw base 12 include a first side rail 28 and a second side rail 30, each side rail 28 and 30 extending in a lateral direction transverse to the rotational plane 26 of the rotatable blade 18 on opposing sides of the motorized rotatable blade 18, or along opposing edges of the upper work table 14. In FIG. 1, the first side rail 28 is positioned in front of the rotatable blade 18 and the second side rail 30 is positioned behind or in back of the rotatable blade 18 and each of the first and second side rails 28 and 30 extend laterally or in a side to side fashion.

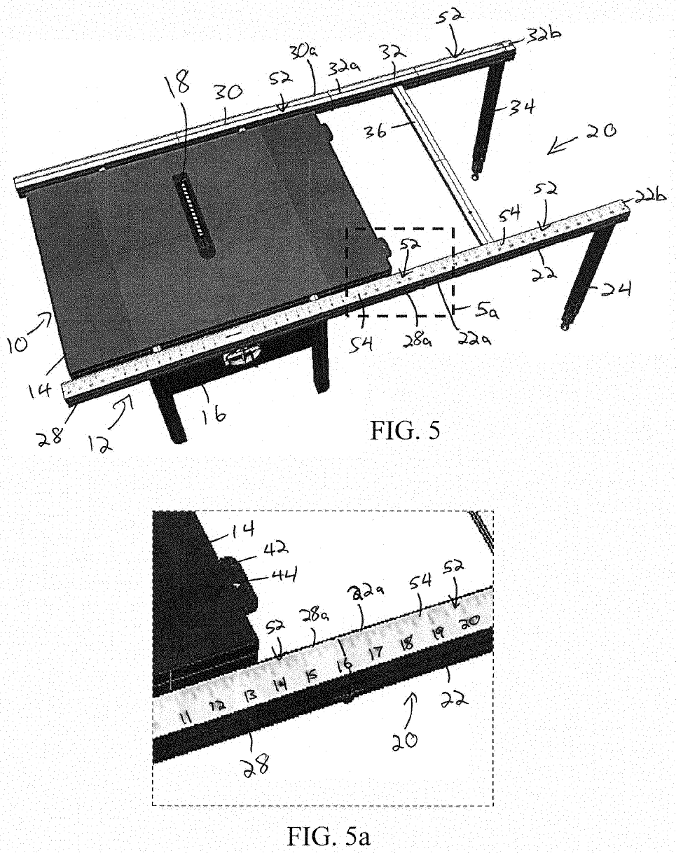

Referring now to FIGS. 4-5, in some embodiments, the table saw extension assembly 20 can include two extension rails 22 and 32, each extension rail 22 and 32 pivotally connected to a corresponding side rail 28 and 30 of the main table saw base 12, respectively. The table saw extension assembly 20 can include two support legs 24 and 34, each support leg 24 and 34 pivotally connected to a corresponding extension rail 22 and 32, respectively. In some embodiments, each of the extension rails 22 and 32 can include a proximal end 22a, 32a and a distal end 22b and 32b, the proximal end 22a, 32a pivotally connected to the corresponding side rail 28 and 30, respectively. Each of the support legs 24 and 34 can be pivotally connected to the distal end 22b and 32b of the corresponding extension rail 22b and 32b, respectively. In some embodiments, each of the proximal end 22a and 32a of the extension rails 22 and 32 can be pivotally connected to lateral ends 28a and 30a of corresponding side rails 28 and 30, respectively. As such, the extension rails 22 and 32 and corresponding side rails 28 and 30 can be pivotally connected in an end to end fashion.

In some embodiments, the table saw extension assembly 20 can include a cross support member 36 extending between the two extension rails 28 and 30. The cross support member 36 can provide stability between the two extension rails 22 and 32 when the extension rails 22, 32 and the extension assembly 20 are in the extended position and during movement of the extension assembly 20 between the extended and a stored or lowered position.

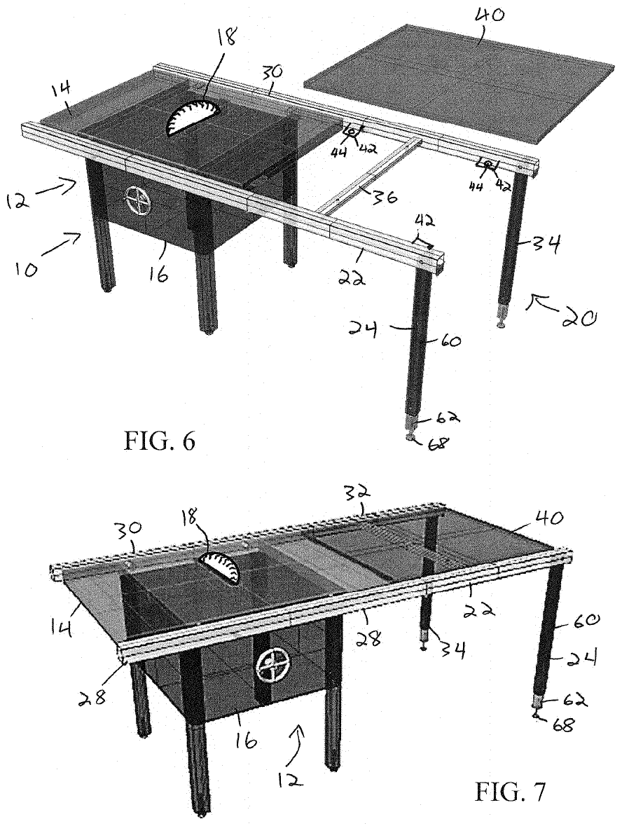

The table saw extension assembly 20 can further include an extension table insert 40 positionable between the two extension rails 22 and 32, as shown in FIGS. 6-7. The extension table insert 40 can be supported in a position between the extension rails 22 and 32 such that the table insert 40 is in a flush orientation with the upper work table 14 on the main saw table base 12. As such, the table insert 40 can act as an extension of the upper work table 14 to support longer work pieces being cut on the table saw apparatus 10.

In some embodiments, the apparatus 10 can further include a plurality of table insert support brackets 42 positioned to support the table insert 40 in a flush orientation with the upper work table 14. The table insert support brackets 42 can be connected or formed on one or more of the upper work table 14, the side rails 28, 30, the rail extensions 22 and 32, and/or the cross support member 36 in various embodiments. In some embodiments, as shown in FIG. 6, support brackets 42 can be formed on the side rails 28 and 30 and/or the extension rails 22 and 32 to support the table insert 40 at multiple locations. In some embodiments, the cross support member 36 can be positioned under and directly support the table insert 42. In other embodiments, the cross support member 36 can include table insert support brackets, such that cross support member 36 can support the table insert 40 via the support brackets on the cross support member 36, and the table insert 40 can have a flush orientation with both the upper work table 14 and the cross support member 36.

In some embodiments, the table insert 40 can simply rest or be placed on the table insert support brackets 42, such that when it is desired for the extension table assembly 20 to be returned to the stored position, the table insert 40 can quickly and conveniently be lifted upward and removed from the support brackets 42. The support legs 24 and 34 and the extension rails 22 and 32 can then be folded as described herein to return the extension assembly to the storage position shown in FIG. 1. In other embodiments, the support brackets 42 can include one or more apertures 44 for removably securing the table insert 40 to the support brackets 42 in a desired position and/or to provide desired spacing between the table insert 40 and the extension rails 22 and 32.

Referring now to FIGS. 5 and 5a, in some embodiments, when the extension rails 22 and 32 are moved to the extended position, the extension rails 22 and 32 can have a flush orientation with corresponding side rails 28 and 30, respectively, and the support legs 24 and 34 can be pivotable on corresponding extension rails 22 and 32 respectively to a vertical orientation. Extension rails 22 and 32 and the side rails 28 and 30 can each have a top surfaces 52, the top surfaces 52 of corresponding extension rails 22, 32 and side rails 28, 30, respectively, having a flush orientation when the extension rails 22 and 32 are in the extended position. In some embodiments, the first and second extension rails 22 and 32 and the first and second side rails 28 and 30 can have congruent cross sections and when the extension rails 22 and 32 move to the extended position, the extension rails 22 and 32 can be oriented to align or be collinear with the corresponding side rail 28 and 30. The apparatus 10 can further include a measuring element 54 extending across the top surfaces 52 of at least one side rail 28 and the corresponding extension rail 22 when the extension rail 22 is in the extended position. The measuring element 54 can be a ruler laid across the top surfaces 52 of the side rail 28 and corresponding extension rail 22 that can allow the user to measure the lateral distance from the end of a worm piece to the rotatable blade 18, and thus the length of a cut for a particular work piece. Because of the flush orientation between the top surfaces 52 of the side rail 28 and the corresponding extension rail 22, the measuring element 54 can be substantially continuous across the side rail 28 and the extension rail 22 which can help provide for accurate measurements with the measuring element 54, even though the extension rail 22 can be folded to the storage position when not in use.

Referring now to FIG. 13, in some embodiments, work table gaps 46 can be formed between the side rails 28 and 32 and the upper work table 14. The work table gaps 46 can allow a fence assembly 48 positioned over the side rails 28 and 30 to slide along the side rails 28 and 30 and be clamped in a desired position on the side rails 28 and 30. Fence assemblies 48 can help the user make square cuts at a desired length with the table saw apparatus 10 by placing work pieces 49 to be cut against the fence assemblies 48 when the fence assembly 48 is clamped to the side rail 28 at a desired distance away from the rotatable blade 18. The table insert 40 when positioned between the extension rails 22 and 32 can form table insert gaps 50 between the table insert 40 and the extension rails 22 and 32. The table insert gaps 50 can extend the work table gaps 46 such that the fence assembly 48 can continuously slide along both the side rails 28 and 30 and the extension rails 22 and 32 when the extension rails 22 and 32 are in the extended position. The flush orientation of the top surfaces 52 of the side rails 28 and 30 and corresponding extension rails 22 and 32 can help provide a smooth transition as the fence assembly 48 passes from the side rails 28 and 30 to the extension rails 22 and 32 and vice versa.

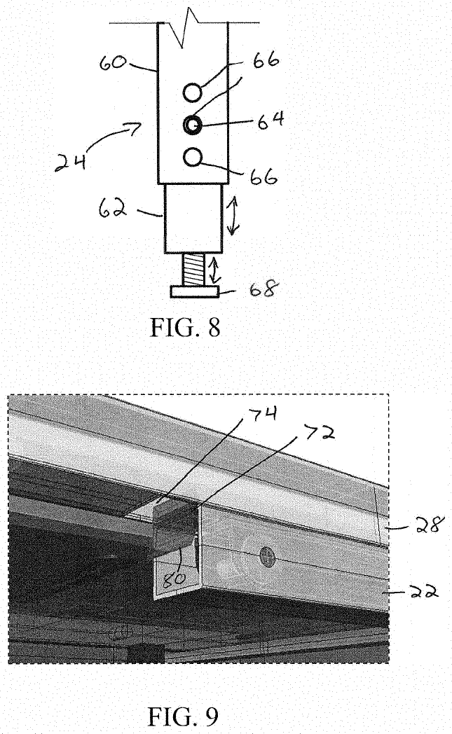

Referring now to FIGS. 6-8, in some embodiments, the support legs 24 and 34 can be telescoping support legs. Each support leg 24 and 34 can include a proximal support leg portion 60 pivotally connected to the corresponding extension rail 22 and 32. Each support leg 24 and 34 can further include a telescoping support leg portion 62 translatable on the proximal support leg portion 60. The telescoping support leg portion 62 is shown in FIG. 8 having a depressible button 64 which can engage spaced apertures 66 on the proximal support leg portion 60, such that coarse adjustment of the height or length of the support leg 24 can be made by adjusting the position of the button in sequential apertures 66 in the proximal support leg portion 60. Any suitable telescoping mechanism can be used to vary and secure the position of the telescoping support leg portion 62 with respect to the proximal support leg portion 60, including but limited to threads, cotter pins, nesting telescoping portions, etc.

In some embodiments, each support leg 24 and 34 can also include an adjustable foot 68 threadingly engaged with the telescoping support leg portion 62. As such, in some embodiments, the height or length of the support legs 24 and 34 can be coarsely adjusted via the telescoping support leg portion 62 and also finely adjusted via the adjustable foot 68. Such adjustment mechanisms on the support legs 24 and 34 can help balance support legs 24 and 34 and the extension assembly 20 when ground or floor surfaces are uneven.

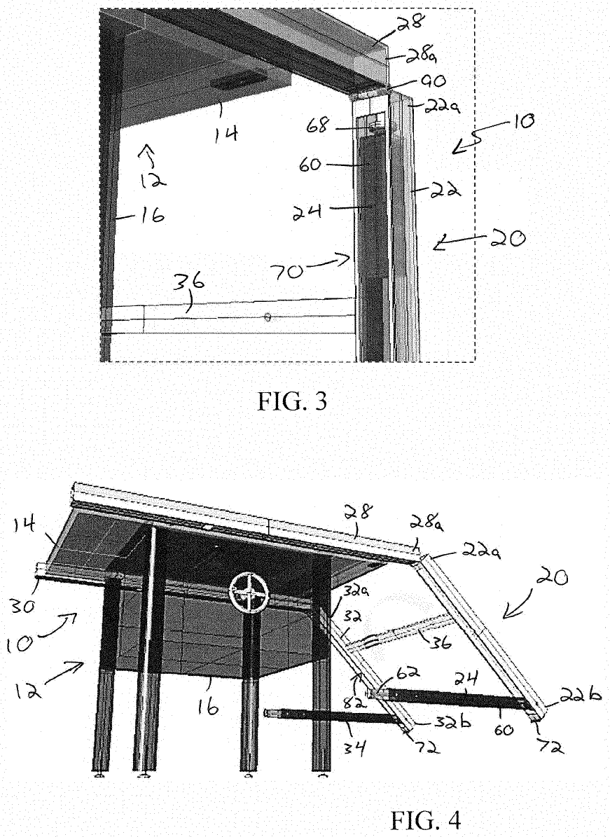

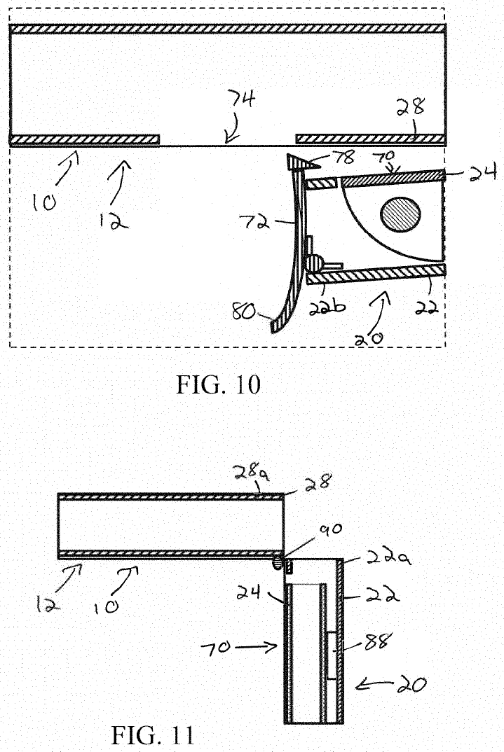

As shown in FIGS. 3 and 9-11, in some embodiments, the at least one extension rail 22 can include a channel 70 defined along a length of the extension rail 22. The at least one support leg 24 can be rotated relative to the at least one extension rail 22 and be received in the channel 70 of the at least one extension rail 22. This can allow for compact storage of the at least one support leg 24 in the extension rail 22 when the extension assembly 20 is placed in a stored or lowered position. In embodiments where the at least one extension rail 22 is pivotally connected to at least one side rail 28 on the main table saw base 12, the at least one support leg 24 can be received in the channel 70 of the at least one extension rail 22, and the at least one extension rail 22 can be rotated to abut against the at least one side rail 28. As such, the at least one extension rail 22 and the support leg 24 can be conveniently stored directly beneath the side rail 28 as shown in FIGS. 1 and 9-10, with the support leg 24 positioned inside the extension rail 22, such that the extension assembly 20 can be out of the way of the operator when not in use.

In some embodiments, the extension rail 22 can include a latch 72 on the at least one extension rail 22 operable to secure the at least one extension rail 22 to the at least one side rail 28. In some embodiments, the lower end of the side rail 28 can include a latch aperture 74 that can receive a portion of the latch 72 to secure the extension rail 22 to the side rail 28. In some embodiments, the latch 72 can be a spring biased latch member that can be pivotally connected to the extension rail 22 and biased in an engagement position via a torsion spring 76 or any suitable biasing mechanism. The latch 72 can include an inclined engagement surface 78 that can be oriented to engage the side rail 28 as the extension rail 22 is pivoted up toward the side rail 28. The inclined engagement surface 78 can force the latch 72 to pivot on the extension rail 22 until the latch 72 clears the side rail 28, wherein the latch 72 is biased back toward the engagement position to engage the latch 72 with the side rail 28 and secure the extension rail 22 to the side rail 28. A release tab 80 on the latch 72 can be manually depressed to pivot the latch 72 on the extension rail 22 and release the extension rail 22 from the side rail 28 when the operator desires to use the extension assembly 20. Any suitable securing mechanism can be utilized to secure the extension rail 22 to the side rail 28, including but not limited to, magnets, clasps, hook and loop fasteners, straps, etc.

Referring again to FIG. 4, a second extension rail 32 pivotally connected to a second side rail 30 can similarly include a second channel 82 into which a second support leg 34 pivotally connected to the second extension rail 32 can be received. The second extension rail 32 can then be rotated to a position beneath the second side rail 30 to secure the second extension rail 30 beneath the second side rail 30 with a similar latch 72 or securing mechanism.

In some embodiments, side rails 28 and 30 and upper work table 14 can extend beyond the base housing 16 of the main table saw base 12. In such embodiments, a cross support member 36 can be positioned along the first and second extension rails 22 and 32 such that the distance between the cross support member 36 to the proximal ends 22a and 32a of the extension rails 22 and 32 is less than the distance which the side rails 28 and 30 extend past the base housing 16. As such, when the extension rails 22 and 32 are pivoted or folded to a position beneath the side rails 28 and 30 respectively, the cross support member 36 does not interfere with the base housing 16.

While FIGS. 1-5 show the extension rails 22 and 32 movable to a stored position directly beneath and secured to the side rails 28 and 30 respectively, in some embodiments the extension rails 22 and 32 can be lowered to a substantially vertical position beneath distal ends 28a and 30a of corresponding side rails 28 and 30. In such embodiments the extension rails 22 and 32 can be sized to make contact with the floor or ground in a substantially vertical orientation such that the extension rails 22 and 32 and/or cross support members 36 don't swing into the main work table base 12 or the operator as they are being lowered.

In some embodiments, the support legs 24 and 34 can be securable to corresponding extension rails 22 and 32 to maintain the support legs 24 and 34 in a folded or stored position with respect to corresponding extension rails 22 and 32. As shown in FIG. 11, in some embodiments, magnets 88 can be positioned on the extension rails 22 and 32 that can magnetically engage support legs 24 made out of a magnetic material such as iron, steel, etc. In other embodiments, retention members such as interference fit catches can be positioned on the extension rails 22 and 32, the catches receiving and retaining the support legs 24 and 32 as they are folded toward or against corresponding extension rails 22 and 32. Any suitable retention member can be used to removably secure the support legs 24 and 34 5o corresponding extension rails 22 and 32, including but not limited to, magnets, clasps, hook and loop fasteners, straps, etc.

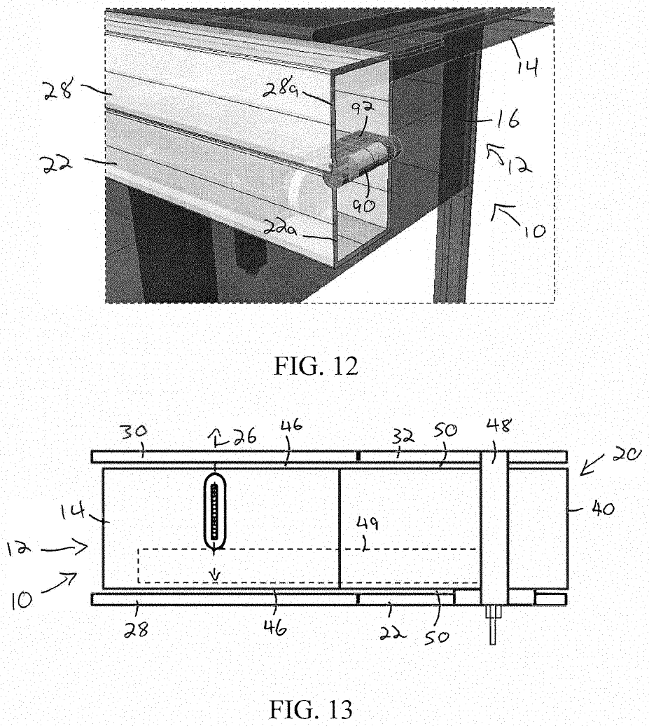

Referring again to FIGS. 5 and 12, another aspect of the present disclosure is an extension assembly apparatus 20 which can be retrofitted to a table saw 10 having a motorized rotatable blade 18 and first and second side rails 28 and 30 extending on opposing sides of the rotatable blade 18 in a lateral direction, the extension assembly apparatus 20 including a first extension rail 22 having a first proximal end 22a and a first distal end 22b, the first proximal end 22a pivotally connectable to the first side rail 28. A second extension rail 32 can have a second proximal end 32a and a second distal end 32b, the second proximal end 32a can be pivotally connectable to the second side rail 30, wherein the first and second extension rails 22 and 32 are movable to an extended position such that the first and second extension rails 22 and 32 are in a flush orientation with the first and second side rails 28 and 30 respectively when the first and second extension rails are pivotally connected to the first and second side rails 28 and 30 respectively. The extension assembly apparatus 20 can further include a first support leg 24 pivotally connected to the first distal end 22b of the first extension rail 22 and a second support leg 34 can be pivotally connected to the second distal end 32b of the second extension rail 32. A cross support member 36 can extend between the first and second extension rails 22 and 32.

In some embodiments, the extension assembly apparatus 20 can further include a hinge assembly 90 on the proximal end 22a and 32a of each extension rail 22 and 32 for pivotally connecting the proximal end 22a and 32a of each extension rail 22 and 32 to a corresponding side rail 28 and 30 of the table saw 10. The hinge assembly 90 can include pivotally connected flanges 92, one flange fixedly connected to the extension rail 22 and the other flange fixedly connectable to the corresponding side rail 28 via any suitable fastening mechanism, including but limited to, welding, adhesion, bolting, screwing, riveting, etc.

The extension assembly apparatus 20 can further include a table insert 40 positionable between the first and second extension rails 22 and 32, the cross support member 36 supporting the table insert 40 when the first and second extension rails are pivotally connected to the first and second side rails 28 and 30 of the table saw 10 respectively and the first and second extension rails 22 and 32 are in the extended position. The table insert 40 can rest on the cross support member 36 directly or can be rest on support brackets extending from the cross support member 36.

In some embodiments, the first extension rail 22 can include a first channel 70 and the first support leg 24 can be receivable in the first channel 70, and the second extension rail 32 can include a second channel 82 and the second support leg 34 can be receivable in the second channel 82.

The table saw apparatuses and extension assemblies disclosed herein can help provide the ability to extend the side rails 28 and 30 on a table saw 10 or a surface that supports the fence assembly 48 as it slides down the extension rails 22 and 32. This provides added versatility for use in different environments. The table saw apparatus 10 can have extension rails 22 and 32 which can be pivotally connected to and thus foldable with respect to a main table saw base 12. The extension rails 22 and 32 can be folded out, and support legs 24 and 34 can be pivotally connected to corresponding extension rails 22 and 32 and can extend downward to support the extension rails 22 and 32 and a table insert 40 positioned between the extension rails 22 and 32 when the extension rails 22 and 32 are in an extended position. When fully extended, extension rails 22 and 32 can be inline and level with the top of the main table saw side rails 28 and 30 and the support legs 24 and 34 can be oriented at a 90-degree angle with respect to the extension rails 22 and 32.

Thus, although there have been described particular embodiments of the present invention of a new and useful Foldable Table Saw Extension Assembly, it is not intended that such references be construed as limitations upon the scope of this invention.

What is claimed is:

1. A table saw apparatus comprising:
a main table saw base;
a motorized rotatable blade disposed on the main table saw base; and
a table saw extension assembly including:
at least one extension rail pivotally connected to the main table saw base, the at least one extension rail movable to an extended position such that the at least one extension rail extends laterally from the main table saw base; and
at least one support leg pivotally connected to the at least one extension rail.

2. The apparatus of claim 1, wherein:
the rotatable blade rotates on the main table saw base along a rotational plane;
the main table saw base includes two side rails extending in a lateral direction transverse to the rotational plane of the rotatable blade on opposing sides of the motorized saw blade; and
the table saw extension assembly includes:
two extension rails, each extension rail pivotally connected to a corresponding side rail of the main table saw base; and
two support legs, each support leg pivotally connected to a corresponding extension rail.

3. The apparatus of claim 2, wherein the table saw extension assembly further comprises a cross support member extending between the two extension rails.

4. The apparatus of claim 2, wherein each of the extension rails includes a proximal end and a distal end, the proximal end pivotally connected to the corresponding side rail, each of the support legs pivotally connected to the distal end of the corresponding extension rail.

5. The apparatus of claim 2, wherein the table saw extension assembly further comprises an extension table insert positionable between the two extension rails.

6. The apparatus of claim 5, further comprising one or more support brackets connected to the side rails and/or the extension rails, the extension table insert positionable on the one or more support brackets when the table insert is positioned between the two extension rails.

7. The apparatus of claim 2, wherein when the extension rails are moved to the extended position, the extension rails have a flush orientation with corresponding side rails and the support legs are pivotable on corresponding extension rails to a vertical orientation.

8. The apparatus of claim 7, wherein:
the extension rails and the side rails each have a top surface, the top surfaces of corresponding extension rails and side rails having the flush orientation when the extension rails are in the extended position; and
the apparatus further comprises a measuring element extending across the top surfaces of at least one side rail and the corresponding extension rail when the extension rail is in the extended position.

9. The apparatus of claim 1, wherein the at least one support leg is a telescoping support leg including:
a proximal support leg portion pivotally connected to the at least one extension rail; and
a telescoping support leg portion translatable on the proximal support leg portion.

10. The apparatus of claim 9, wherein the support leg further comprises an adjustable foot member threadingly engaged with the telescoping support leg portion.

11. The apparatus of claim 1, wherein:
the at least one extension rail includes a channel defined along a length of the extension rail; and
the at least one support leg can be rotated relative to the at least one extension rail and be receivable in the channel of the at least one extension rail.

12. The apparatus of claim 11, wherein:
the main table saw base includes at least one side rail extending laterally on the main table saw base, the at least one extension rail pivotally connected to at least one side rail;
when the at least one support leg is receivable in the channel of the at least one extension rail, the at least one extension rail can be rotated to abut against the at least one side rail.

13. The apparatus of claim 12, further comprising a latch on the at least one extension rail operable to secure the at least one extension rail to the at least one side rail.

14. The apparatus of claim 13, further comprising a magnet on the at least one extension rail for securing the at least one support leg to the at least one extension rail.

15. A table saw apparatus comprising:
a main table saw base including:
an upper work table;
a motorized rotatable blade disposed on the main table saw base and extending through the upper work table, the rotatable blade rotating along a rotational plane; and
a first side rail and a second side rail extending in a direction transverse to the rotational plane adjacent opposing edges of the upper work table, the first side rail having a first side rail end and the second side rail having a second side rail end; and
a table saw extension assembly including:
a first extension rail having a first proximal end and a first distal end, the first proximal end pivotally connected to the first end of the first side rail;
a second extension rail having a second proximal end and a second distal end, the second proximal end pivotally connected to the second end of the second side rail;
a first support leg pivotally connected to the first distal end of the first extension rail; and
a second support leg pivotally connected to the second distal end of the second extension rail.

16. The apparatus of claim 15, further comprising:
the first and second extension rails movable to an extended position wherein the first and second extension rails are collinear with the first and second side rails respectively;
a cross support member extending between the first and second extension rails; and
a table insert positionable between the first and second extension rails when the first and second extension rails are in the extended position with the table insert supported by the cross support member.

17. An extension assembly apparatus for a table saw having a motorized rotatable blade and first and second side rails extending on opposing sides of the rotatable blade in a lateral direction, the extension assembly apparatus comprising:
a first extension rail having a first proximal end and a first distal end, the first proximal end pivotally connectable to the first side rail;
a second extension rail having a second proximal end and a second distal end, the second proximal end pivotally connectable to the second side rail, wherein the first and second extension rails are movable to an extended position such that the first and second extension rails are in a flush orientation with the first and second side rails respectively;
a first support leg pivotally connected to the first distal end of the first extension rail;
a second support leg pivotally connected to the second distal end of the second extension rail; and
a cross support member extending between the first and second extension rails.

18. The extension assembly apparatus of claim 17, further comprising a hinge assembly on the proximal end of each extension rail for pivotally connecting the proximal end of each extension rail to a corresponding side rail of the table saw.

19. The extension assembly apparatus of claim 17, further comprising a table insert positionable between the first and second extension rails, the cross support member supporting the table insert when the first and second extension rails are pivotally connected to the first and second side rails of the table saw respectively and the first and second extension rails are in the extended position.

20. The extension assembly of claim 17, wherein:
the first extension rail includes a first channel and the first support leg can be receivable in the first channel; and
the second extension rail includes a second channel and the second support leg can be receivable in the second channel.
